(19) United States
(12) Patent Application Publication
(10) Pub. No.: US 2011/0173324 A1
(43) Pub. Date: Jul. 14, 2011

(54) METHOD, APPARATUS, AND SYSTEM FOR ACCESSING SERVICES OVER THE EXTENSIBLE MESSAGING AND PRESENCE PROTOCOL

(76) Inventors: Huan Wang, Shenzhen (CN); Yan Li, Shenzhen (CN); Qifeng Ma, Shenzhen (CN); Xiaomin Shi, Makati (PH); Heng Chang, Shenzhen (CN)

(21) Appl. No.: 13/051,757

(22) Filed: Mar. 18, 2011

Related U.S. Application Data
(63) Continuation of application No. PCT/CN2009/073768, filed on Sep. 4, 2009.

(30) Foreign Application Priority Data
Sep. 19, 2008 (CN) 200810222647.3

(51) Int. Cl. G06F 15/173

(52) U.S. Cl. 709/225

(57) ABSTRACT

An XMPP server in a home domain that an XMPP client belongs to receives a service access request over XMPP; the XMPP server selects a routing path for the service access request, and forwards the service access request to a next hop XMPP server according to the selected routing path, and forwards the service access request in turn, to an XMPP gateway connected to a service server; after the XMPP gateway receives the service access request, the XMPP gateway invokes the service server to obtain a service access response, and forwards the service access response to the XMPP server in the home domain that the XMPP client belongs to; the XMPP server in the home domain that the XMPP client belongs to sends the service access response to the XMPP client.

### CROSS-REFERENCE TO RELATED APPLICATIONS

This application is a continuation of International Application No. PCT/CN2009/073768, filed on Sep. 4, 2009, which claims priority to Chinese Patent Application No. 200810222647.3, filed on Sep. 19, 2008, both of which are hereby incorporated by reference in their entireties.

### FIELD OF THE INVENTION

The present invention relates to communication technologies, and in particular, to a method, an apparatus, and a system for accessing services over the Extensible Messaging and Presence Protocol (XMPP).

### BACKGROUND OF THE INVENTION

Currently, service access gradually develops towards web-based access. A client accesses the web service mainly through interactions with a service server over the Simple Object Access Protocol (SOAP). Moreover, SOAP messages are generally carried over the Hypertext Transfer Protocol (HTTP). Because HTTP is a unidirectional and stateless protocol, it supports only a synchronous request-response interaction mode. When the client accesses a stateful service, especially when the client accesses some services that can be executed only after a long period of time or when the client obtains an asynchronous message, the client needs to continually poll the service server by sending query requests over HTTP to synchronize service information. This problem is caused by the request-response mode of HTTP. Because the server cannot push the service information to the client actively, the server can return a response only after the client sends a request. Even if the client is able to receive an HTTP request, the service server cannot push messages to the client because a firewall may be deployed on the client or the Internet service provider (ISP). Therefore, in the asynchronous message application, only the polling mode can be used to obtain messages during service access over HTTP. This increases network communication overheads and loads of the service server.

A technical solution in the prior art provides a WS-Addressing solution. In the WS-Addressing solution, a mode similar to the next hop routing mode in the Transmission Control Protocol/Internet Protocol (TCP/IP) is used, where only a final receiving address is specified and middle routers do not need to be specified. The message includes information about the source and destination of the message, but does not include detailed information about how the message reaches the destination. When a SOAP message is transmitted on the network, each node checks the header of the SOAP message to determine the destination of the SOAP message, and then sends the message to a next SOAP node which is closer to the destination. This process continues until the message reaches the destination.

During the implementation of the present invention, the inventor discovers at least the following problems in the prior art:

The WS-Addressing solution cannot satisfy requirements for accessing some services. For example, to balance network loads, the router may specify different routing paths for different requests, and these requests reach a same destination; or to satisfy some applications with high security requirements, the service access message needs to be transmitted according to a particular path; or some particular nodes need to be passed through or other policy requirements need to be satisfied.

### SUMMARY OF THE INVENTION

Embodiments of the present invention provide a method, an apparatus, and a system for accessing services over XMPP.

The objective of embodiments of the present invention is achieved through the following technical solution:

A method for accessing services over XMPP includes:

receiving, by an XMPP server in a home domain that an XMPP client belongs to, a service access request carried over XMPP;

selecting, by the XMPP server, a routing path for the service access request, forwarding the service access request to a next hop XMPP server according to the selected routing path, and forwarding the service access request in turn, to an XMPP gateway connected to a service server;

after receiving, by the XMPP gateway, the service access request, invoking the service server to obtain a service access response, and forwarding the service access response to the XMPP server in the home domain that the XMPP client belongs to; and

sending, by the XMPP server in the home domain that the XMPP client belongs to, the service access response to the XMPP client.

An apparatus for accessing services over)(MIT includes:

a stream managing module, configured to manage the states of an extensible markup language (XML) stream connection and session with other entities;

a route configuring module, configured to select a routing path for an XMPP message; and

a routing module, configured to route the XMPP message on the XML stream between each entity.

A system for accessing services over XMPP includes an XMPP server, an XMPP gateway, and a service server.

The XMPP server is configured to: receive a service access request over XMPP, select a routing path for the service access request, and forward, according to the selected routing path, the service access request to the XMPP gateway connected to the service server.

The XMPP gateway is configured to: invoke the service server to obtain a service access response, and forward the service access response to the XMPP server.

In embodiments of the present invention, a service is accessed over XMPP, and a bidirectional connection may be established between a service server and a service access client; in a stateful session, the service server can push the state information to the service access client to synchronize the service state information. In this way, the client does not need to poll the service server periodically to obtain the session state, thus reducing the server load and network traffic and improving the real-time performance of the service.

In addition, the routing path element is extended in XMPP, so that the client or the XMPP server can specify a routing path for the service access message. In this way, the efficiency and reliability of the service access are improved, thus balancing the network loads and service loads and implementing policy control and security control over the service access message.

### BRIEF DESCRIPTION OF THE DRAWINGS

FIG. 1 shows an architecture of a system for accessing services over XMPP according to a first embodiment of the present invention;

FIG. 2 illustrates each device module in the system for accessing services over XMPP according to the first embodiment of the present invention;

FIGS. 3A and 3B illustrate a flowchart of a method for accessing services over XMPP according to a second embodiment of the present invention; and

FIG. 4 is a flowchart of a method for accessing services over XMPP according to a third embodiment of the present invention.

### DETAILED DESCRIPTION OF THE EMBODIMENTS

The technical solution under the present invention is expounded below with reference to the accompanying drawings. Apparently, the embodiments described below are exemplary only, without covering all embodiments of the present invention. Those skilled in the art can derive other embodiments from the embodiments given herein without creative effort, and all such embodiments are covered in the scope of the present invention.

In embodiments of the present invention, services are accessed by carrying a SOAP message over XMPP. XMPP is an open XML protocol. It exchanges structured information between any two network terminals in real time by using an XML stream, featuring multi-platform compatibility and easy scalability. XMPP provides a universal and extensible framework to exchange XML data, and can transmit different types of XML data, such as instant messages, texts, and data.

In embodiments of the present invention, services are accessed by carrying a SOAP message over XMPP, so that the client and the service server can send messages to each other. This overcomes the defect that the SOAP message is carried over HTTP based on the request-response mode, that is, the service server cannot actively push the message to the client.

In addition, in embodiments of the present invention, XMPP is extended. A routing path element is defined in XMPP, so that a message can be routed to the destination according to a preset path, which overcomes the problem in the WS-Addressing solution that a service cannot be accessed according to a specified path. The method for defining a routing path element in XMPP may include: extending a <service> stanza in XMPP, and defining related elements needed for accessing the service in the <service> stanza. The <service> stanza has two types, that is, the type values of the <service> stanza may be ‘access’ and ‘reply’. The <service> stanza of the ‘access’ type is used for the service access request, while the <service> stanza of the ‘reply’ type is used for the service access response.

In the <service> stanza, a message routing path element <path> is defined, which includes child elements <fwd> and <rev>. The child elements <fwd> and <rev> may include one or more <via> elements and are used to record nodes that the message needs to pass through. The XMPP server forwards the message according to the path information. Adding the <path> element enables the XMPP server to specify a routing path for the service access according to the network condition, routing policy, and QoS requirement.

Optionally, the step of extending XMPP in embodiments of the present invention may further include: adding an element indicating whether the service access response can be buffered on the XMPP server. The method for adding an element indicating whether the service access response can be buffered on the XMPP server may include: defining a <buffer> element in the <service> stanza, where the <buffer> element indicates whether the service access response can be buffered on the XMPP server. If the value of the <buffer> element is set to ‘no’, it indicates that the service access response cannot be buffered; if the value of the <buffer> element is set to ‘yes’, it indicates that the service access response can be buffered on the XMPP server. When the response reaches the XMPP server in the home domain that the XMPP client belongs to, the XMPP server judges whether the XMPP client is online; if the XMPP client is offline, the XMPP server may judge, according to the value of the <buffer> element, whether the service access response can be buffered. This solution can make full use of the XMPP server, increases the message processing flexibility, and avoids a problem that the service server fails to send a message when the XMPP client is offline.

Optionally, to facilitate the conversion between SOAP carried over XMPP and SOAP carried over HTTP, a <SOAPAction> element may be defined in the <service> stanza, and corresponds to the <SOAPAction> element in the header of HTTP. The <SOAPAction> element defines the intent of the SOAP request. The server (for example, the firewall that filters the SOAP request over HTTP) may determine whether to filter the message by using the value of the <SOAPAction> element.

The following describes the implementation mode of the service access over XMPP with reference to specific embodiments.

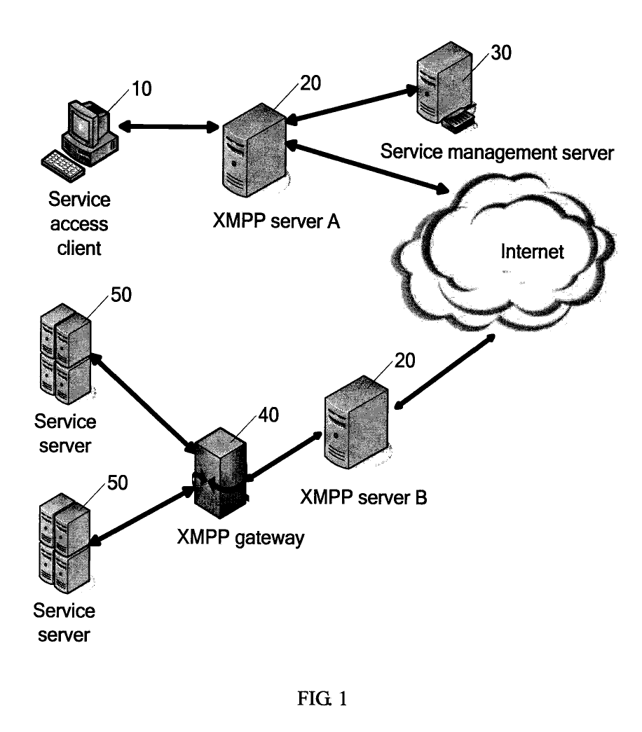

The first embodiment provides a system for accessing services over XMPP. As shown in FIG. 1, the system includes a service access client 10, an XMPP server 20 (e.g., an XMPP server A and an XMPP server B show in FIG. 1), a service management server 30, an XMPP gateway 40, and a service server 50.

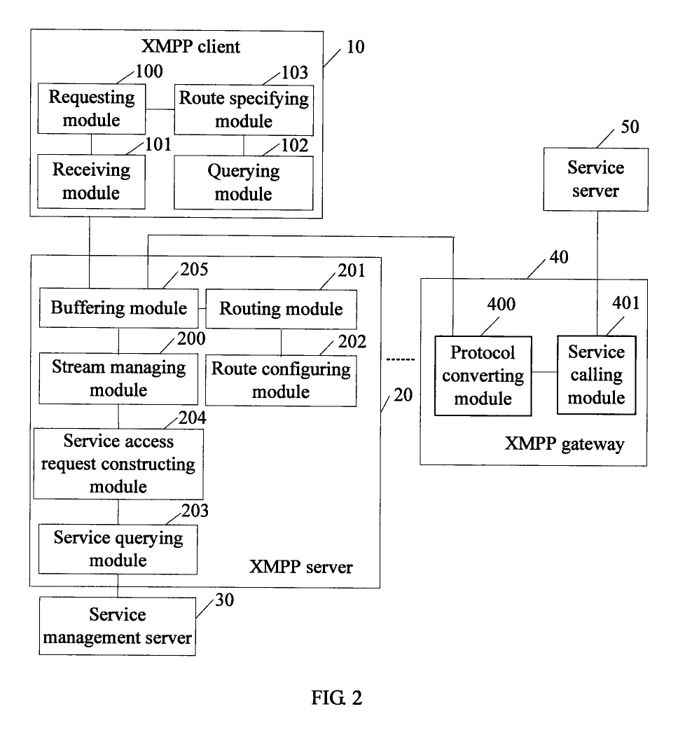

The service access client 10 is a client that supports XMPP, that is, the client is an XMPP client. The service access client 10 registers with the XMPP server A in the home domain that the service access client belongs to. The service access client 10 accesses services over extended XMPP. As shown in FIG. 2, the service access client 10 includes:

a requesting module 100, configured to send, over XMPP, a service access request that may carry a routing path specified by the service access client 10; and

a receiving module 101, configured to receive a service access response that the XMPP server 20 sends over XMPP. That is, the receiving module 101 parses an XMPP message, and obtains a service access result.

Optionally, if the service access client 10 does not know the service access information, for example, the address and parameter of a service server 50, the service access client 10 further includes:

a querying module 102, configured to send a service query request for service access information to the XMPP server A, where the service query request includes the function description, key words, parameter information and QoS requirements of the service to be accessed. The QoS requirement may include response time, security, and costs.

Optionally, the service access client 10 may further include:

a route specifying module 103, configured to specify a routing path for the service access in the service access request, where the specified routing path may be a whole path or a segment of the path of the accessed service, or a necessary node for accessing the service, for example, the XMPP server B.

The service access client 10 may be a final service user or one of combined service users.

The XMPP server 20 is configured to: receive a service access request, select a routing path for the service access request, forward the service access request, receive a service access request that the service access client 10 carries over XMPP, configure a routing path for the service access request, forward, according to the routing path, the service access request to the XMPP gateway 40 connected to the service server, query for the service access information after receiving the service query request from the service access client 10, and feed back the queried service access information to the service access client 10. The XMPP server 20 may also construct a service access request according to the service access information.

As shown in FIG. 2, the XMPP server 20 includes a stream managing module 200, a routing module 201, and a route configuring module 202. Optionally, the XMPP server 20 includes one or more of the following: a service querying module 203, a service access request constructing module 204, and a buffering module 205.

The stream managing module 200 is configured to manage the states of an XML stream connection and session with other entities, for example, manage the XML stream connection and registration with the XMPP client.

The routing module 201 is configured to route an XMPP message on an XML stream established between each entity, where the XMPP message may be a service access request or a service access response.

The route configuring module 202 is configured to: obtain and exchange the current network condition, and select a routing path according to the network condition, routing policy, and QoS requirement.

The service querying module 203 is configured to: receive a service query request sent from the service access client 10, and query the service management server 30 for the service access information (including web services description language (WSDL) messages) according to the service query request. For example, the service querying module 203 queries the service management server list according to the QoS requirement in the service query request, selects a service, and returns the access method description of the service.

The service access request constructing module 204 is configured to construct a service access request according to the service access information and the service query request.

The buffering module 205 is configured to: judge whether to buffer the service access response or subscription data sent to the service access client 10, and buffer the contents that need to be buffered. The method for judging whether to buffer the service access response or subscription data includes: judging whether the service access client 10 is online; if the service access client 10 is online, sending the service access response or subscription data directly, without buffering, to the service access client 10; if the service access client 10 is offline, judging whether the message includes a <buffer> element and whether the value of the <buffer> element is “yes”; if the message includes a <buffer> element and the value of the <buffer> element is “yes”, buffering the message; if the message does not include a <buffer> element or the value of the <buffer> element is “no”, not buffering the message.

The suspension points in FIG. 2 indicate that there may be multiple XMPP servers between the XMPP server A, with which the client registers, and the XMPP gateway 40.

The service management server 30 is configured to: take charge of service registration, store the function description information of specific services, maintain the QoS information (including the load ratio, the response time, and whether the server is available for serving, etc) of each service server 50, and provide, according to the function description information of the service, the XMPP server 20 with service access information, that is, the service access method description. The service management server 30 is similar to or may be equivalent to a universal description, discovery, and integration (UDDI) server in the web service.

The XMPP gateway 40 is configured to: invoke the service server to obtain a service access response, forward the service access response to the XMPP server, and perform conversion between XMPP and other protocols. The XMPP gateway 40 is a logical entity, which may be an independent XMPP server 20 or be integrated with the service server 50 in a same machine. The XMPP gateway 40 is an XMPP server with specific functions. As shown in FIG. 2, the XMPP gateway 40 also includes a protocol converting module 400 and a service invoking module 401 besides the functional modules of the XMPP server 20.

The protocol converting module 400 is configured to perform conversion between an XMPP message and other protocol messages. For example, if the service server 50 supports only an HTTP request, the protocol converting module needs to translate the XMPP message into an HTTP message. After the XMPP gateway 40 receives an HTTP response from the service server 505, the XMPP gateway 40 converts the HTTP response into an XMPP message.

The service invoking module 401 is configured to: parse the XMPP message, invoke the service server 50 to obtain a service access response, and encapsulate the service access response into the XMPP message. In this embodiment, the XMPP server or the XMPP gateway is called an apparatus for accessing services over XMPP.

The service server 50 is a device for providing specific services and can provide web service interfaces for the access of other devices. For example, after the service server 50 receives a service access request from the XMPP gateway 40 and processes the service access request, the service server 50 sends a response to the XMPP gateway 40.

In the first embodiment of the present invention, the system uses XMPP as the bearer protocol for the service access, and can establish a bidirectional connection between the service server 50 and the service access client 10; in a stateful session, the service server 50 can actively push the state information to the service access client 10 so as to synchronize the service state information. In this way, the service access client 10 does not need to poll the service server 50 periodically to obtain the session state, thus reducing the server load and network traffic and improving the real-time performance of the service.

In addition, because a routing path element is extended in XMPP, the service access client 10 or the XMPP server 20 can specify a routing path for the service access message. The XMPP server 20 may specify a routing path according to factors such as the QoS requirement, network condition, policy control, and security in the service access message. In this way, the efficiency and reliability of the service access are improved, thus balancing the network loads and service loads and implementing policy control and security control over the service access message.

Further, by using the feature that the XMPP client 10 needs to register with the XMPP server 20, when the XMPP server sends specific services to the XMPP client 10, the XMPP server detects whether the XMPP client 10 is online, and judges, according to the message type, whether to buffer the service access response or subscription data sent to the XMPP client 10. This solves the problem that the service server 50 fails to send messages when the XMPP client 10 is offline.

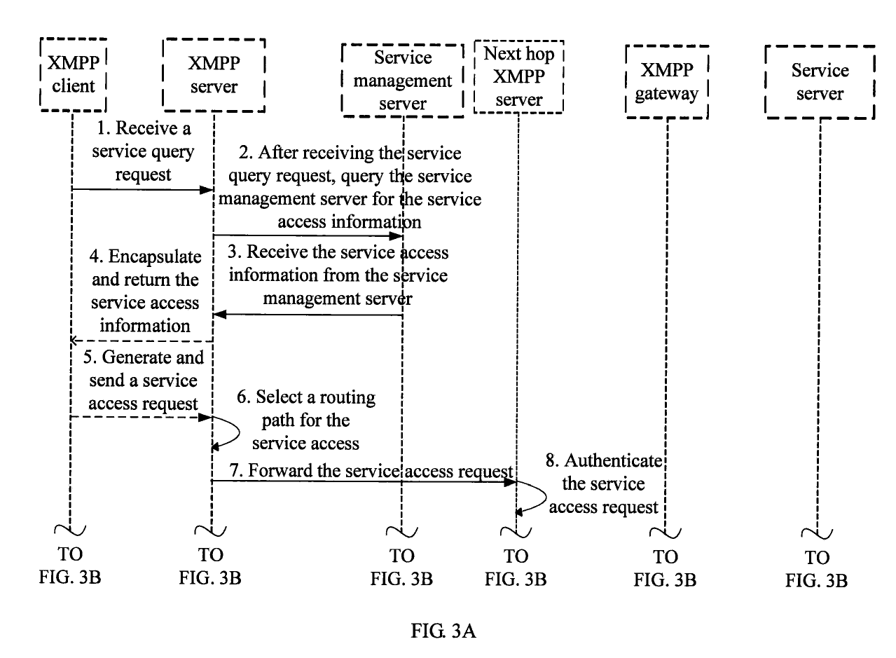

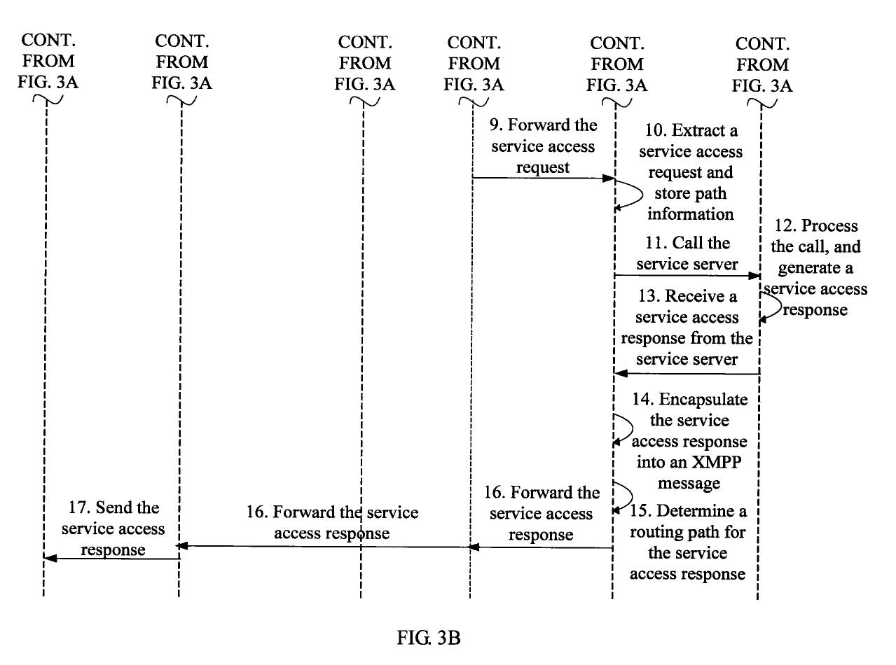

The second embodiment of the present invention provides a method for accessing services over XMPP. In this embodiment, supposing the XMPP client does not know the server address of a specific service, the method shown in FIG. 3 includes the following steps:

Step 1: The XMPP server in the home domain that the XMPP client belongs to receives a service query request, sent from the XMPP client, for obtaining service access information.

Because it is assumed that the XMPP client does not know the server address of a specific service, the XMPP client sends, before sending a service access request, a service query request for obtaining the service access information, to the XMPP server, where the service query request carries information such as the service function, parameter, and QoS requirement of the service to be accessed. The service query request may be encapsulated into an XML stanza of an <IQ/> or <Message/> type, and the XML stanza is sent to the XMPP server. For example, the process includes:

```
<iq from=‘Alice@example.com’ id=‘s01’ type=‘get’>
  <function>airline ticket</function>
    <Qos>
      <response-time>5</response-time>
    </QoS>
</iq>;
```

It should be noted that, before sending the service query request to the XMPP server, the XMPP client needs to register with the XMPP server in the home domain that the XMPP client belongs to.

Step 2: After receiving the service query request sent from the XMPP client, the XMPP server queries the service management server for the service access information.

After receiving the service query request, the XMPP server obtains services that satisfy the information carried in the service query request from the service management server list.

Step 3: The XMPP server receives the service access information returned from the service management server.

The service management server may provide one, or multiple or no services that satisfy the information carried in the service query request. If multiple services are provided, the service management server returns multiple pieces of service access description information to the XMPP server; if no service is provided, the service management server returns error information indicating that no service is available.

For example, the service management server returns a piece of service access information as follows:

```
<? xml version=“1.0” encoding=“UTF-8” ?>
<definitions name=“Tickets”
    targetNamespace=“www.airline.com/booktickets-interface”
    xmlns=“http://schemas.xmlsoap.org/wsdl/”
    xmlns:soap=“http://schemas.xmlsoap.org/wsdl/soap/”
    xmlns:tns=“http://www.airline.com/bookTicketService”
    xmlns:xsd=“http://www.w3.org/1999/XMLSchema”>
  <portType name=“BookTicket”>
    <operation name=“Query”>
        .......
        .......
    </operation>
    <operation name=“book”>
      .......
      .......
    </operation>
  </portType>
</definitions>;
```

Step 4: The XMPP server encapsulates the service access information into a service access stanza, and then returns the service access stanza to the XMPP client.

If the service management server returns multiple pieces of service access description information, the XMPP server selects a service according to information such as QoS defined by the service.

The service access information may be returned to the XMPP client in the form of WSDL, which includes information needed for service access, such as the service address (URL), message (<message>), port (<portType>), data type (<types>), and binding transfer protocol (<banding>).

For example, the XMPP server returns the following information:

```
<iq to=‘Alice@example.com’ from=‘server@example.com’ id=‘s01’
type=‘result’>
  <wsdl>
    ....
</wsdl>
</iq>
```

If the service management server returns error information, the XMPP server may also return error information to the XMPP client.

Step 5: The XMPP client generates a service access request according to the obtained service access information, and sends the service access request to the XMPP server.

The following gives a description of an embodiment of generating, by the XMPP client, a service access request:

```
<env:Envelope xmlns:env=“http://www.w3.org/2003/05/soap-envelope”>
  <env:Header>
    ...
  </env:Header>
  <env:Body>
    <location>Shenzhen</location>
    <date>2008-3-21</date>
  </env:Body>
</env:Envelope>;
```

After generating the service access request, the XMPP client encapsulates the service access request into the <service> stanza, and sends the <service> stanza to the XMPP server. Details are as follows:

```
      <service to=‘www.airline.com/portal/quely’
from=‘Alice@exmaple.com’ id=‘s02’ type=‘access’>
        <soap>
        <env:Envelope xmlns:env=“http://www.w3.org/2003/05/soap-
        envelope”>
          <env:Header>
          </env:Header>
          <env:Body>
            <location>Shenzhen</location>
            <date>2008-3-21</date>
          </env:Body>
        </env:Envelope>
        </soap>
      </service>;
```

In another embodiment of the present invention, the XMPP server may construct a service access request after obtaining the service access information and parameters provided by the service access client. That is, when the service access client sends a service query request, the service access client sends a service access parameter to the XMPP server at the same time. In this way, the XMPP server does not need to feed back the service access information to the XMPP client. Thus, step 4 and step 5 are optional.

Step 6: The XMPP server selects a routing path for service access.

The XMPP server searches for the network condition and routing policy information according to the destination address of the service access request, so as to configure a path for service access.

If the service access request is sent from the XMPP client and includes a complete routing path, the XMPP server executes step 7 directly. If the service access request includes an incomplete routing path, the XMPP server optimizes the routing path according to the QoS requirement, routing policy, and network condition of the service access request, and adds the optimized routing path to the routing path <path> element of the XML message. If the service access request includes no routing path information, the XMPP server configures a complete routing path according to the QoS requirement, routing policy, and network condition of the service access request, and adds a routing path to the routing path <path> element of the XML message. For example, the current service access request needs to be authenticated by the SOAP://authentication.A.com node. The details are as follows:

```
      <service to=‘www.airline.com/portal/query’
from=‘Alice@exmaple.com’ id=‘s02’ type=‘access’>
          <path>
            <fwd>
              <via>SOAP://authentication.A.com</via>
              <via>SOAP://encryption.B.com</via>
            </fwd>
            <rev>
            <via>server@example.com</via>
          </rev>
          </path>
      <SOAPAction>www.airline.com/portal#query</SOAPAction>
          <soap>
            <env:Envelope
xmlns:env=“http://www.w3.org/2003/05/soap-envelope”>
            <env:Header>
              <messageID>s000001</message>
            </env:Header>
            <env:Body>
              <location>Shenzhen</location>
              <date>2008-3-21</date>
            </env:Body>
            </env:Envelope>
          </soap>
      </service>;
```

Step 7: The XMPP server forwards the service access request to a next hop XMPP server.

The XMPP server selects a next hop XMPP server according to the content in the routing path <path>. Before sending the service access request to the next hop XMPP server, the XMPP server judges whether the XMPP server has already established an XML stream connection with the next hop XMPP server; if not, the XMPP server establishes an XML stream connection with the next hop XMPP server before sending the service access request to the next hop XMPP server.

Step 8: The next hop XMPP server may authenticate the service access request.

If the authentication succeeds, the process proceeds to step 9; if the authentication fails, the process ends, and the next hop XMPP server sends an authentication failure notification to the XMPP client. Step 8 is optional.

Step 9: The next hop XMPP server forwards the service access request to a next hop XMPP server, and this process continues until the service access request is forwarded to the XMPP gateway.

The next hop XMPP server deletes the local node information in the routing path message after the authentication succeeds, and adds local node information in a reverse path. Then, the next hop XMPP server forwards the message to a next hop XMPP server in the routing path. The method is repeated until the service access request is sent to the XMPP gateway connected to the service server. For example, a forwarding process is as follows:

```
      <service to=‘www.airline.com/portal/query’
from=‘Alice@exmaple.com’ id=‘s02’ type=‘access’>
        <path>
          <fwd>
            <via>SOAP://encryption.B.com</via>
          </fwd>
          <rev>
            <via>SOAP://authentication.A.com</via>
            <via>server@example.com</via>
          </rev>
        </path>
      <SOAPAction>www.airline.com/portal#query</SOAPAction>
          <soap>
            <env:Envelope
xmlns:env=“http://www.w3.org/2003/05/soap-envelope”>
            <env:Header>
            </env:Header>
            <env:Body>
              <location>Shenzhen</location>
              <date>2008-3-21</date>
            </env:Body>
            </env:Envelope>
          </soap>
      </service>;
```

Step 10: After receiving the service access request, the XMPP gateway extracts a service access request and stores information, such as path information, so as to generate a response.

After receiving a service access request, the XMPP gateway extracts the service access request, which is encapsulated into the <service> stanza, and stores the routing path information in the <service> stanza, so as to generate a response.

Step 11: The XMPP gateway invokes the service server.

If the message format supported by the service server is inconsistent with the message format of a service access request received by the XMPP gateway, the XMPP gateway converts the service access request into a format supported by the service access request, and invokes the service of the service server.

Step 12: The service server processes the invoking, and generates a service access response.

Step 13: The XMPP gateway receives a service access response returned from the service server.

For example, the following is a process of returning, by the service server, a service access response to the XMPP gateway:

```
<env:Envelope xmlns:env=“http://www.w3.org/2003/05/soap-envelope”>
<env:Header>
<messageID>s000001</messageID>
</env:Header>
<env:Body>
  <item>
    <airline number>CA001</airline number>
    <time>9:00AM</time>
    <price>1800RMB</price>
    ...
  </item>
  <item>
    ...
  </item>
</env:Body>
</env:Envelope>;
```

Step 14: The XMPP gateway encapsulates the service access response into an XMPP message.

Step 15: The XMPP gateway determines a routing path for the service access response.

The XMPP gateway checks whether the service access request corresponding to the service access response carries routing path information; if the service access request corresponding to the service access response carries routing path information, the XMPP gateway uses the routing path in the routing path information as the routing path of the response. If no routing path information is carried, the XMPP gateway selects a forwarding path for the service access response. For example:

```
      <service to=‘ Alice@exmaple.com’ from=‘
www.airline.com/portal/query’ id=‘s02’ type=‘reply’>
      <path>
          <rev>
            <via>SOAP://encryption.B.com</via>
            <via>SOAP://authentication.A.com</via>
            <via>server@example.com</via>
          </rev>
        </path>
        SOAPAction>www.airline.com/portal#query</SOAPAction>
      <soap>
          <env:Envelope xmlns:env=“http://www.w3.org/2003/05/soap-
          <envelope”>
          <env:Header>
            <messageID>s000001</messageID>
          </env:Header>
          <env:Body>
            <item>
              <airline number>CA001</airline number>
              <time>9:00AM</time>
              <price>1800RMB</price>
              ...
            </item>
            <item>
              ...
            </item>
          </env:Body>
          </env:Envelope>
      </soap>
      </service>;
```

The routing path information carried in the service access response may be routing path information corresponding to the service access request or reverse path information.

Step 16: The XMPP gateway forwards the service access response to the XMPP server directly connected to the XMPP client.

The forwarding process is similar to the process of routing the service access request, and is not repeatedly described.

Step 17: The XMPP server directly connected to the XMPP client deletes route-related information, and sends the service access response to the corresponding XMPP client.

If the XMPP server finds, after detection, that the destination address of the response is a client in a domain managed by the XMPP server, the XMPP server deletes route information, and then sends the response to the client.

```
      <service to=‘ Alice@exmaple.com’ from=‘
www.airline.com/portal/query’ id=‘s02’ type=‘reply’>
      <soap>
        <env:Envelope xmlns:env=“http://www.w3.org/2003/05/soap-
        envelope”>
          <env:Header>
          <messageID>s000001</messageID>
          </env:Header>
          <env:Body>
            <item>
                <airline number>CA001</airline number>
                <time>9:00AM</time>
                <price>1800RMB</price>
                ...
            </item>
            <item>
                ...
            </item>
          </env:Body>
          </env:Envelope>
        </soap>
      </service>.
```

In the second embodiment of the present invention, XMPP is used as the bearer protocol of the service network, and a bidirectional connection can be established between the service server and the service access client; in a stateful session, the service server can actively push the state information to the client so as to synchronize the service state information. In this way, the client does not need to poll the service server periodically to obtain the session state, thus reducing the server load and network traffic and improving the real-time performance of the service.

In addition, because a routing path element is extended in XMPP, the client or the XMPP server can specify a routing path for the service access message. The XMPP server may specify a routing path according to factors such as the QoS requirement, network condition, policy control, and security in the service access message. In this way, the efficiency and reliability of the service access are improved, thus balancing the network loads and service loads and implementing policy control and security control over the service access message.

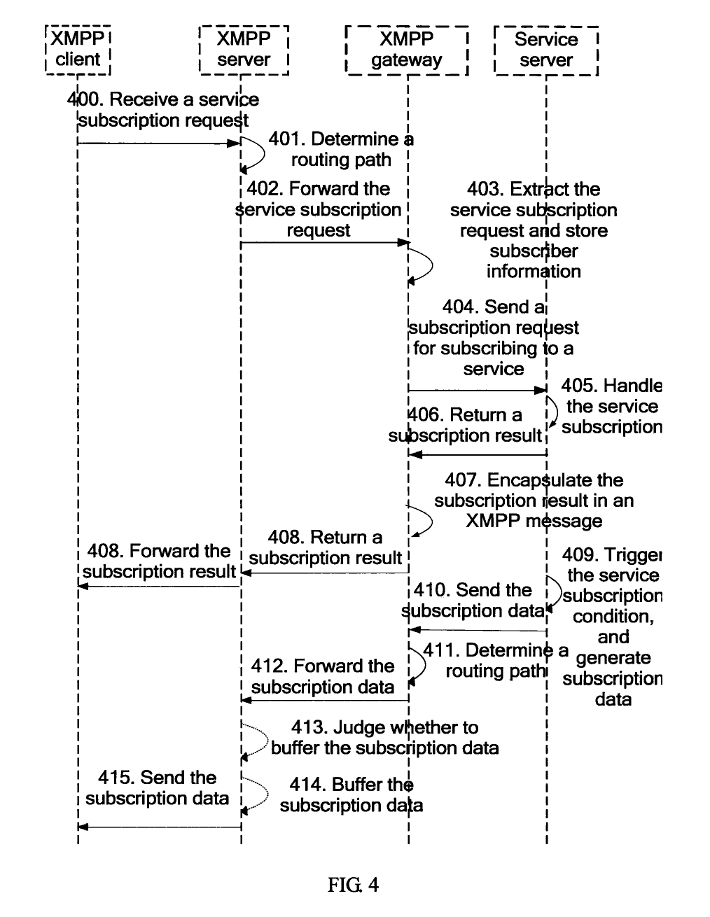

The third embodiment of the present invention provides a method for accessing services over XMPP. This embodiment is based on an example that the XMPP client subscribes to a service and an assumption that the XMPP client already knows the address of the service server. As shown in FIG. 4, the method provided in the third embodiment of the present invention includes the following steps:

Step 400: The XMPP server in the home domain that the XMPP client belongs to receives a service subscription request sent from the XMIPP client. For example:

```
      <service to=‘www.weather.com/portal/subscription’
from=‘Alice@exmaple.com’ id=‘s03’ type=‘access’>
        <buffer>yes</buffer>
        <soap>
          <env:Envelope xmlns:env=“http://www.w3.org/2003/05/soap-
          envelope”>
            <env:Header>
            </env:Header>
            <env:Body>
                <location>Shenzhen</location>
            </env:Body>
          </env:Envelope>
          </soap>
      </service>;
```

Step 401: After receiving the service subscription request, the XMPP server determines a routing path for the service subscription request. The process is similar to that in the first embodiment, and is not repeatedly described.

Step 402: The XMPP server forwards the service subscription request to a next hop XMPP server, and this process continues until the service subscription request is forwarded to the XMPP gateway connected to the service server.

Certainly, the XMPP server may also not specify a routing path. In this case, the <path/> element in the service access stanza is a null element, indicating that the routing path of the message is not limited. The XMPP server forwards the service subscription request to a next hop XMPP server, and this process continues until the service subscription request is forwarded to the XMPP gateway connected to the service server.

```
      <service to=‘www.weather.com/portal/subscription’
from=‘Alice@exmaple.com’ id=‘s03’ type=‘access’>
        <path/>
        <buffer>yes</buffer>
        <SOAPAction>www.weather.com/portal/subscription
        </SOAPAction>
        <soap>
          <env:Envelope xmlns:env=“http://www.w3.org/2003/05/soap-
          envelope”>
            <env:Header>
            </env:Header>
            <env:Body>
              <location>Shenzhen</location>
            </env:Body>
          </env:Envelope>
        </soap>
      </service>;
```

Step 403: After receiving the service subscription request, the XMPP gateway extracts a service subscription request and stores information, such as the requester (e.g., an XMPP client), so as to generate a response.

After receiving the <service> stanza, the XMPP gateway extracts a service subscription request which is encapsulated into the <service> stanza, and stores information such as the requester in the <service> stanza, so as to generate a response.

Step 404: The XMPP gateway invokes a service server interface to send a subscription request for subscribing to a service. For example:

```
<env:Envelope xmlns:env=“http://www.w3.org/2003/05/soap-envelope”>
  <env:Header>
  </env:Header>
  <env:Body>
    <location>Shenzhen</location>
  </env:Body>
</env:Envelope>;
```

Step 405: The service server handles the service subscription.

Step 406: The service server returns a subscription result to the XMPP gateway, that is, it returns a subscription confirmation message, for example:

```
<env:Envelope xmlns:env=“http://www.w3.org/2003/05/soap-envelope”>
  <env:Body>
  <state> successful</state>
  </env:Body>
</env:Envelope>;
```

Step 407: The XMPP gateway encapsulates the subscription result into an XMPP message, for example:

```
      <service to=‘Alice@exmaple.com’ from=‘ www.weather.-
com/portal/subscription’ id=‘s03’ type=‘reply’>
        <SOAPAction>www.weather.com/portal/subscription
        </SOAPAction>
        <soap>
          <env:Envelope xmlns:env=“http://www.w3.org/2003/05/soap-
          envelope”>
            <env:Body>
              <state>successful</state>
            </env:Body>
          </env:Envelope>
        </soap>
      </service>;
```

Step 408: The XMPP gateway forwards the subscription result through one or more XMPP servers to an XMPP client which has subscribed to the service.

The XMPP gateway forwards the subscription result through one or more XMPP servers. Finally, the XMPP server in the home domain that the XMPP client that subscribes to the service belongs to, sends the subscription result to the XMPP client. The subscription result includes a subscription success confirmation message or a subscription failure message.

Step 409: When the service logic of the service server triggers the service subscription condition, the service server processes the subscription request and generates subscription data, for example:

```
<env:Envelope xmlns:env=“http://www.w3.org/2003/05/soap-envelope”>
  <env:Header>
  </env:Header>
  <env:Body>
    <weather>cloudy</weather>
    <temperature>15-23</temperature>
  </env:Body>
</env:Envelope>;
```

Step 410: The service server sends the subscription data to the XMPP gateway.

Step 411: The XMPP gateway determines a routing path for the subscription data in a mode the same as that in the first embodiment. For example:

```
      <service to=‘Alice@exmaple.com’ from=‘ www.weather.-
com/portal/subscription’ id=‘s03’ type=‘reply’>
        <buffer>yes</buffer>
        <SOAPAction>www.weather.com/portal/subscription
        </SOAPAction>
        <soap>
          <env:Envelope xmlns:env=“http://www.w3.org/2003/05/soap-
          envelope”>
            <env:Body>
                <state>successful</state>
            </env:Body>
          </env:Envelope>
        </soap>
      </service>;
```

Step 412: The XMPP gateway sends the subscription data to a next hop XMPP server, and this process continues until the subscription data is forwarded to the XMPP server in the home domain that the XMPP client belongs to.

Step 413: The XMPP server judges whether to buffer the subscription data. Step 413 is optional.

The method for judging whether to buffer the subscription data includes: judging whether the XMPP client is online; if the XMPP client is offline, judging whether the message includes a <buffer> element and whether the value of the <buffer> element is “yes”; if the message includes a <buffer> element and the value of the <buffer> element is “yes”, proceeding to step 414, that is, buffering the subscription data, and proceeding to step 415 after the XMPP client logs in to the XMPP server; if the message does not include a <buffer> element or the value of the included <buffer> element is “no”, not buffering the subscription data, and sending failure related information to the service server (where the step of sending failure related information to the service server is optional);

if the XMPP client is online, proceeding to step 415, that is, sending the subscription data directly to the XMPP client, for example:

```
      <service to=‘Alice@exmaple.com’ from=‘ www.weather.-
com/portal/subscription’ id=‘s03’ type=‘reply’>
        <SOAPAction>www.weather.com/portal/subscription
        </SOAPAction>
        <soap>
          <env:Envelope xmlns:env=“http://www.w3.org/2003/05/soap-
          envelope”>
              <env:Body>
                <state>successful</state>
              </env:Body>
          </env:Envelope>
        </soap>
      </service>.
```

In this embodiment, XMPP is used as the bearer protocol of the service network, and a bidirectional connection can be established between the service server and the service access client; in a stateful session, the service server can actively push the state information to the client so as to synchronize the service state information. In this way, the client does not need to poll the service server periodically to obtain the session state, thus reducing the server load and network traffic and improving the real-time performance of the service. In addition, because a routing path element is extended in XMPP, the service access client or the XMPP server can specify a routing path for the service access message. The XMPP server may specify a routing path according to factors such as the QoS requirement, network condition, policy control, and security of the service access. In this way, the efficiency and reliability of the service access are improved, thus balancing the network loads and service loads and implementing policy control and security control over the service access message. Further, in this embodiment, a message is buffered, so that the service server may send the message successfully when the XMPP client is offline.

In conclusion, in embodiments of the present invention, accessing services over XMPP has made the following obvious progress:

A bidirectional connection can be established between the service server and the service access client; in a stateful session, the service server can push the state information to the service access client so as to synchronize the service state information. In this way, the client does not need to poll the service server periodically to obtain the session state, thus reducing the server load and network traffic and improving the real-time performance of the service.

In addition, because a routing path element is extended in XMPP, the service access client or the XMPP server can specify a routing path for the service access message. The XMPP server may specify a routing path according to factors such as the QoS requirement, network condition, policy control, and security of service access. In this way, the efficiency and reliability of the service access are improved, thus balancing the network loads and service loads and implementing policy control and security control over the service access message.

A message is buffered, so that the service server can send the message successfully when the XMPP client is offline.

The above descriptions are merely some exemplary embodiments of the present invention, but not intended to limit the scope of the present invention. Any modification, equivalent replacement, or improvement made without departing from the spirit and principle of the present invention should fall within the scope of the present invention. Therefore, the scope of the present invention is subject to the appended claims.

What is claimed is:

1. A method for accessing services over the Extensible Messaging and Presence Protocol (XMPP), comprising:
receiving, by an XMPP server in a home domain that an XMPP client belongs to, a service access request carried over XMPP;
selecting, by the XMPP server, a routing path for the service access request, forwarding the service access request to a next hop XMPP server according to the selected routing path, and forwarding the service access request in turn, to an XMPP gateway connected to a service server;
after receiving, by the XMPP gateway, the service access request, invoking a service server to obtain a service access response, and forwarding the service access response to the XMPP server in the home domain that the XMPP client belongs to; and
sending, by the XMPP server in the home domain that the XMPP client belongs to, the service access response to the XMPP client.

2. The method according to claim 1, wherein before the step of receiving, by the XMPP server in the home domain that the XMPP client belongs to, the service access request carried over XMPP, the method further comprises:
by the XMPP server in the home domain that the XMPP client belongs to, receiving a service query request, sent from the XMPP client, for obtaining service access information; and
obtaining, by the XMPP server, service access information from a service management server according to the service query request, and feeding back the service access information to the XMPP client.

3. The method according to claim 1, wherein before the step of receiving, by the XMPP server in the home domain that the XMPP client belongs to, the service access request carried over XMPP, the method further comprises:
receiving, by the XMPP server in the home domain that the XMPP client belongs to, a service query request, sent from the XMPP client, for obtaining service access information;
obtaining, by the XMPP server, service access information from a service management server according to the service query request; and
generating, by the XMPP server, the service access request according to the service access information and the service query request.

4. The method according to claim 1, wherein the step of selecting, by the XMPP server, the routing path for the service access request comprises:
if the service access request comprises a complete routing path, selecting, by the XMPP server, the routing path in the service access request as the routing path for the service access; and
if the service access request comprises an incomplete routing path or the service access request does not comprise routing path information, selecting, by the XMPP server, a complete routing path for the service access according to the queried network condition, routing policy, and quality of service (QoS) requirement of the service access request.

5. The method according to claim 1, wherein the step of forwarding the service access request to a next hop XMPP server according to the selected routing path and forwarding the service access request in turn, to the XMPP gateway connected to the service server comprises:
sending, by the XMPP server, the service access request to a next hop XMPP server in the selected routing path; and
deleting, by the next hop XMPP server, information of the XMPP server in the routing path, adding the information of the XMPP server to a reverse path, and forwarding the service access request to a next hop XMPP server, and this process continues until the service access request is forwarded to the XMPP gateway connected to the service server.

6. The method according to claim 1, wherein after receiving, by the XMPP gateway, the service access request and before invoking related services of the service server, the method further comprises:
converting, by the XMPP gateway, the format of the service access request into a format that is supported by the service servers.

7. The method according to claim 6, wherein after receiving, by the XMPP gateway, the service access request and before invoking related services of the service server, the method further comprises:
storing, by the XMPP gateway, routing path information of the service access request or XMPP client information of the service access request.

8. The method according to claim 7, wherein the step of forwarding, by the XMPP gateway, the service access response to the XMPP server in the home domain that the XMPP client belongs to comprises:
judging, by the XMPP gateway, whether to store the routing path information of the service access request corresponding to the service access response;
if the routing path information of the service access request is already stored, forwarding, according to the stored routing path, the service access response to the XMPP server in the home domain that the XMPP client belongs to; and
if the routing path information of the service access request is not stored, generating, according to the stored XMPP client information of the service access request, a routing path for the service access response, and forwarding, according to the generated routing path, the service access response to the XMPP server in the home domain that the XMPP client belongs to.

9. The method according to claim 1, wherein: the XMPP has a defined <server> stanza, and the <server> stanza comprises a message routing path element <path> that comprises one or more child elements configured to record nodes that the routing path needs to pass through.

10. The method according to claim 9, wherein the type property of the <server> stanza comprises access and reply, wherein the access refers to a service access request and the reply refers to a service access response.

11. The method according to claim 1, wherein the step of sending, by the XMPP server in the home domain that the XMPP client belongs to, the service access response to the XMPP client comprises:
judging, by the XMPP server in the home domain that the XMPP client belongs to, whether the XMPP client is online;
if the XMPP client is online, sending the service access response to the XMPP client; and
if the XMPP client is offline, judging whether the service access response carries a buffer element <buffer> and whether the value of the <buffer> element is “yes”; if the service access response carries a buffer element <buffer> and the value of the <buffer> element is “yes”, buffering the service access response, and sending the service access response to the XMPP client after the XMPP client logs in; if the service access response does not carry the <buffer> element or the value of the carried <buffer> element is “no”, discarding, without buffering, the service access response.

12. An apparatus for accessing services over the Extensible Messaging and Presence Protocol (XMPP), comprising:
a stream managing module, configured to manage states of an extensible markup language (XML) stream connection and session with other entities;
a route configuring module, configured to select a routing path for an XMPP message; and
a routing module, configured to route the XMPP message on the XML stream between each entity of the selected routing path.

13. The apparatus according to claim 12, further comprising:
a service querying module, configured to: receive a service query request sent from a service access client, and query for service access information according to the service query request; and
a service access request constructing module, configured to construct a service access request according to the queried service access information and the service query request.

14. The apparatus according to claim 12, further comprising:
a buffering module, configured to: judge whether a service access response sent to the client needs to be buffered, and buffer the service access response that needs to be buffered.

15. The apparatus according to claim 12, further comprising:
a protocol converting module, configured to perform conversion between an XMPP message and other protocol messages; and/or
a service invoking module, configured to: parse the XMPP message, invoke a service server to obtain a service access response, and encapsulate the service access response into the XMPP message.

16. A system for accessing services over the Extensible Messaging and Presence Protocol (XMPP), comprising an XMPP server, an XMPP gateway, and a service server, wherein:
the XMPP server is configured to: receive a service access request over XMPP, select a routing path for the service access request, and forward, according to the selected routing path, the service access request to the XMPP gateway connected to the service server, and
the XMPP gateway is configured to: invoke the service server to obtain a service access response, and forward the service access response to the XMPP server.

17. The system according to claim 16, further comprising:
a service management server, configured to: take charge of service registration, store function description information of specific services, maintain current quality of service (QoS) information of various service servers, and provide the XMPP server with service access information.
